(19) United States
(12) Patent Application Publication
(10) Pub. No.: US 2008/0199015 A1
(43) Pub. Date: Aug. 21, 2008

(54) INFANT SPEECH RECORDING DEVICE

(76) Inventor: Kenna Okko, Aliso Viejo, CA (US)

Correspondence Address: WEST & ASSOCIATES, A PC, 2815 MITCHELL DRIVE, SUITE 209, WALNUT CREEK, CA, 94598, US

(21) Appl. No.: 11/676,173

(22) Filed: Feb. 16, 2007

(51) Int. Cl. H04R 29/00; G08B 23/00

(52) U.S. Cl. 381/56; 340/573.1

(57) ABSTRACT

A portable recording device to capture a child's first words without the need for constant surveillance, as well as provide additional monitoring functions.

### BACKGROUND

1. Field of the Invention

The present disclosure is for a device that captures sounds, such as the first words, spoken by an infant, and can also monitor and entertain the infant.

### BACKGROUND

It is a thrill for parents to watch the development of their child. As the child reaches each milestone, parents are eager to capture the moment and, if possible, record the event for the child's own records or to share with others. For example, many parents use video cameras to capture exciting events like the child's first steps, words, birthday, or other “firsts.”

However, sometimes it can be difficult to predict when a developmental “first” will occur. With respect to walking, parents can rely on cues, such as the child standing on her own or pushing herself up, to make themselves aware that walking may be imminent and prepare the camera to capture the moment. Even then, they may still miss it and have to settle for video footage of the subsequent steps. Further, some children will suddenly become very shy when they know that they are being monitored or recorded.

A child's first word is another important milestone that can occur even more spontaneously than walking. Parents can try to capture it by having a recording device handy or perhaps even constantly recording at all times. However, this constant surveillance can be tedious and difficult to maintain.

In addition to frequently or continuously monitoring the child to capture milestones, some parents may also want to supervise or monitor the child for safety or comfort. For example, many parents place a music player in the child's room to soothe her to sleep or use a “baby monitor” to keep tabs on the child remotely. However, these devices are often confined to the child's room. Portable music players exist, of course, and a baby monitor can be moved from room to room. However, when moving a child around, having another item to carry can be inconvenient.

What is needed is a device that can continually and automatically record a child's sounds and capture significant events, such as a child's first word, which can then be saved and shared with others. In addition, such a device can also be combined with a baby monitor and music player to provide one convenient, portable, unit that can travel with the child.

### BRIEF DESCRIPTION OF THE DRAWINGS

FIG. 1 depicts a schematic diagram of an embodiment of the present device.

FIG. 2 depicts an embodiment of the present device in use.

FIG. 3 depicts another embodiment of the present device in use.

### DETAILED DESCRIPTION

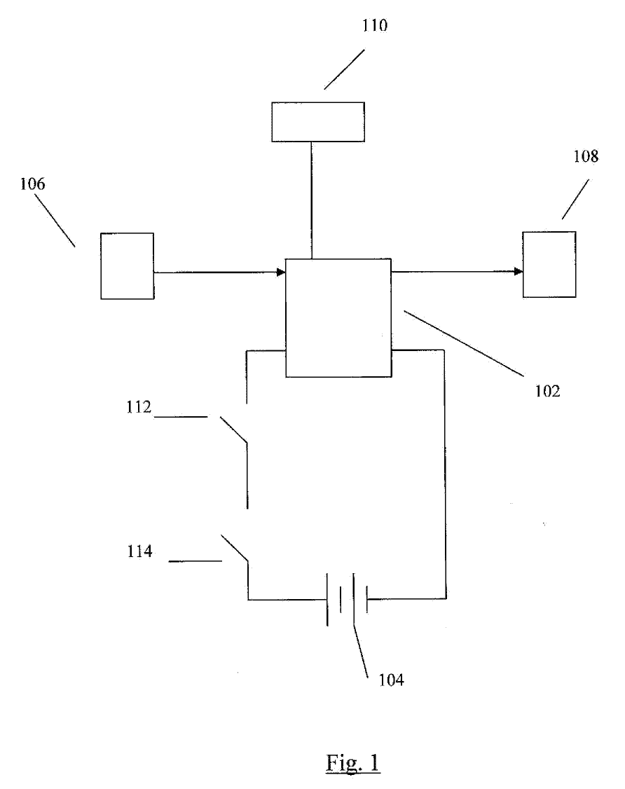

FIG. 1 depicts a schematic diagram of an embodiment of the present device. A recording and data storage unit 102 can be connected to a power supply 104, which can be a battery or any other known and/or convenient device. An input device 106 and an output device 108 can each be connected to or integrated with a recording unit 102. A display screen 110 can also be connected to a recording unit 102. A manual switch 112 and a sound-activated switch 114 can be connected in a circuit between said recording unit 102 and power supply 104.

In some embodiments, a recording unit 102 can be a digital device capable of running on a continuous recording loop. The duration of recording time can be any known and/or convenient span of time. In some embodiments, a recording and data storage unit 102 can continue recording for a specified duration and then automatically begin a new recording cycle unless a user intervenes to stop the recording loop. A recording and data storage unit 102 can also have the capability of providing a time/date stamp for the recorded material. Other embodiments can have an additional switch that allows a user to switch between loop-recording and non-loop-recording modes. Some embodiments can also have a display screen 110 to allow a user to interface with a recording and data storage unit 102.

In some embodiments, an input device 106 can be a microphone or any other known and/or convenient device. An input device 106 can be removably coupled with a recording unit 102 via a jack, plug, or any other known and/or convenient device. In other embodiments, an input device 106 can be integrated with a recording unit 102, such that they are permanently connected. Some embodiments can include an additional input device 106 capable of connecting to a computer or any other known and or convenient source of sound files, such as songs or soothing sounds. In these embodiments, the device can also playback recorded songs and sounds to entertain or soothe the child.

In some embodiments, an output device 108 can be a speaker, earphones, a connector port, or any other known and/or convenient device. In some embodiments, a speaker can be used to hear the recorded audio. In other embodiments, a connector port can allow a recording unit 102 to be connected to a personal computer so that the recorded audio can be downloaded for playback, processing, and storage on a computer.

In some embodiments, a manual switch 112 can turn the device off when not in use or when the user desires to stop the continuous playback loop. In some embodiments an additional sound-activated switch 114 can trigger a recording unit 102 to begin recording when the child begins making sounds. In such embodiments, a recording unit 102 can be turned on manually to operate on a continuous recording loop when triggered by a sound-activated switch 114, which would also stop recording when sounds have stopped. The device would be on stand-by until a sound-activated switch 114 was again triggered. A user can then manually switch off the device after the desired sounds have been recorded to stop the recording loop.

Other embodiments of the present device can further include devices to assist in monitoring the child's activity and location. A transmitter unit to transmit the baby's sounds to a receiver in a remote location can be combined with the recording and data storage unit 102. A GPS tracking device can also be included in the present device to assist in locating a child who becomes lost.

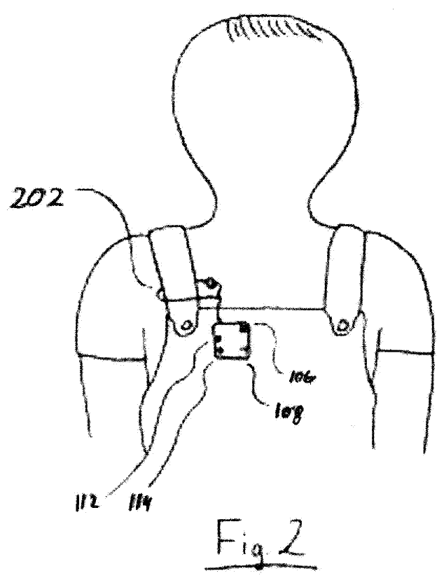

As shown in FIG. 2, in some embodiments, the present device can be an independent device that can attach to any of the aforementioned pieces of baby equipment either as a separate product or as a set. In the embodiment shown in FIG. 2, the present device attaches to a child's clothing with an attaching member 202. However, the present device can be attached by clips, hooks, snaps, buttons, hook-and-loop closures, or any other known and/or convenient device. In other embodiments, the present device can operate as a “stand-alone” device that can be placed in proximity to the child, rather than on the child.

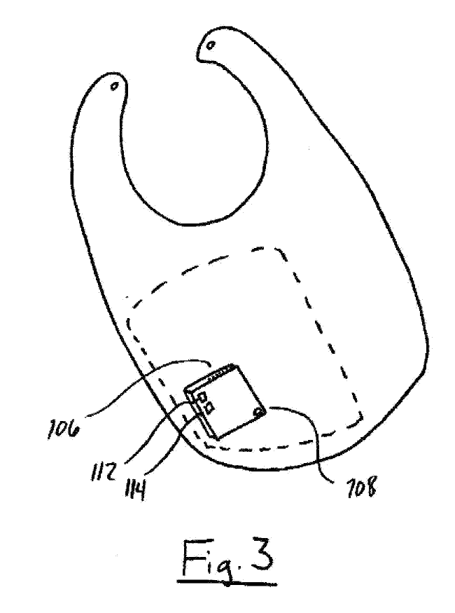

In other embodiments, as shown in FIG. 3, the present device can be integrated with a piece of baby equipment, such as a pacifier, bib, clothing, car seat, carrier, stroller, toy, bag, or any other known and/or convenient item. FIG. 3 depicts an embodiment of the present device integrated into a bib. A cutaway view shows an embodiment of the present device set inside the bib, with the switches 112, 114, input device 106, and output device 108 accessible from the outer surface of the bib.

In use, the present device is placed either on the child's person or in close proximity to the child. In embodiments having both a manual switch 112 and a sound-activated switch 114, present device is first turned on by a manual switch 112 to await activation by a sound-activated switch 114. When the child makes a sound, a sound-activated switch 114 activates a recording unit 102. Sounds enter a recording unit 102 via a microphone 106 and a recording unit 102 begins recording any sounds that the child makes for a specified time interval. If the child does speak her first word, or other desired utterance, during this interval, a user can then stop the recording loop by a manual switch 112 to capture the sounds. A user can then listen to the captured sounds via an output device 108. In embodiments that have a playback feature and a speaker as an output device, a user can play the recording back and hear it immediately. In other embodiments that have a connector port by which the present device can be connected to a computer, a user can download the recorded material to a computer and listen to it, process it, or save it from there.

In embodiments that include a recording from an outside source and playback capabilities, a user can download music or other soothing sounds to the present device. A user can use the playback mode of the present device so the child can then listen to the music or sounds.

In embodiments that include a “baby monitor” feature, a user can set the present device to record and/or transmit the baby's sounds to a remote receiver. Since the present device can be positioned in close proximity to the baby, a user does not need to worry about if it is close enough to pick up the baby's sounds, as with conventional baby monitors that are positioned next to a crib or somewhere else in a room. Also, if a user needs to move the child to another location, the present device conveniently moves with the child.

In embodiments that include a GPS monitoring system, the present device can emit a GPS signal that could be picked up by any known and/or convenient GPS monitoring device. Although a child of the age where he is just uttering his first words isn't likely to wander off and get lost, an older child using the present device could get separated from his parents or caretaker. In the event a child is lost, a GPS device can receive the signal from the present device and locate the child quickly and efficiently.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed is:

1. A device to record auditory input from a child, comprising:
a digital recording unit capable of recording audio signals and storing said audio signals,
input means capable of picking up auditory input from the child,
output means capable of playing back or transferring a recorded audio signal,
power supply means capable of supplying power to the digital recording unit, input means and output means,
and a connecting member capable of securing said device to an object where the device can monitor auditory input from a child.

2. The device of claim 1, wherein said object to which said device is secured to record a child's auditory input is selected from the group consisting of pacifiers, bibs, articles of clothing, bags, toys, strollers, carriers, cribs, playpens, and car seats.

3. The device of claim 1, further comprising sound-activation means, said sound activation means capable of turning on the digital recording unit upon receiving audio signals to begin recording and storing said audio signals, and said digital recording unit stopping recording after a pre-defined period of not receiving audio signals.

4. The device of claim 1, wherein said recording unit time/date stamps a recording.

5. The device of claim 1, wherein said output device is either an audio speaker or a connector port.

6. The device of claim 1, further comprising a display screen capable of displaying information regarding the status of the recording unit.

7. The device of claim 1, further comprising a transmitter and a remote receiver capable of receiving a signal from said transmitter.

8. The device of claim 1, further comprising an additional input means capable of transferring audio signals from a remote source to the recording unit.

9. The device of claim 1, further comprising a GPS tracking unit.

10. A device to record auditory input from a child, comprising:
a digital recording unit capable of recording audio signals in either a looping or non-looping recording mode and storing said audio signals, input means capable of picking up auditory input from the child, output means capable of playing back or transferring a recorded audio signal,
power supply means capable of supplying power to the digital recording unit, input means and output means,
an item of child-related gear, wherein said device is integrated with said item of child-related gear.

11. The device of claim 10, wherein said item of child-related gear is selected from the group consisting of: pacifiers, bibs, articles of clothing, bags, toys, strollers, carriers, cribs, playpens, and car seats.

12. The device of claim 10, further comprising sound-activation means, said sound activation means capable of turning on the digital recording unit upon receiving audio signals to begin recording and storing said audio signals, and said digital recording unit stopping recording after a pre-defined period of not receiving audio signals.

13. The device of claim 10, wherein said recording unit time/date stamps a recording.

14. The device of claim 10, wherein said output device is either an audio speaker or a connector port.

15. The device of claim 10, further comprising a display screen, wherein said display screen is connected to said recording unit.

16. The device of claim 10, further comprising a transmitter and a remote receiver capable of receiving a signal from said transmitter.

17. The device of claim 10, further comprising an additional input means capable of transferring audio signals from a remote source to the recording unit.

18. The device of claim 10, further comprising a GPS tracking unit.

19. The device of claim 1, wherein said recording unit is capable of recording in a continuous loop of a pre-defined period of time by recording over previous stored recordings until stopped by a user.
